(19) United States
(12) Patent Application Publication
(10) Pub. No.: US 2010/0012862 A1
(43) Pub. Date: Jan. 21, 2010

(54) Mechanism of adjusting irradiating angle for a far infrared radiator

(76) Inventor: Chia Hao Chang, Tainan (TW)

Correspondence Address: Chia Hao Chang, No. 149 (Room 9, 10/F.), Lin Sen Road, Sec. 1, Tainan, 701, TW

(21) Appl. No.: 12/218,547

(22) Filed: Jul. 17, 2008

(51) Int. Cl. G21K 5/00

(52) U.S. Cl. 250/504 R; 250/522.1

(57) ABSTRACT

A mechanism of adjusting irradiating angle for a far infrared radiator includes an elbow connected between a joint and an irradiating hood and provided with a stage of corrugated flexible tube. The elbow has a combining end portion connected with the flexible tube for combining with the irradiating hood, with a locking slot formed in a surface of the combining end portion for being tightly fitted with a screw. So the corrugated flexible tube can be bent with diverse angles; the irradiating hood can be circularly rotated; and the joint can let the elbow swing up and down. The irradiating hood can be thus adjusted to randomly shift its irradiating angle without difficulty or any dead angle caused

### BACKGROUND OF THE INVENTION

1. Field of the Invention

This invention relates to a mechanism of adjusting irradiating angle for a far infrared radiator, particularly to one able to randomly change its irradiating angle without a dead one.

2. Description of the Prior Art

As disclosed in Taiwan Patent No, 447312, a conventional far infrared instrument with an adjustable joints mechanism mainly includes two joints, with a first joint positioned at a top of a supporting post for connecting with one end of an arm, and with a second joint being a direction-shifting mechanism jointed together with the other end of the supporting post and an irradiating hood. As the two joints can be only moved up and down, the whole far infrared instrument must be moved around in case that the irradiating hood is to be horizontally moved to alter its direction. Moreover, the stand of the conventional far infrared instrument is not foldable so that the far infrared instrument is bulkily packaged, soaring delivery and manpower cost.

### SUMMARY OF THE INVENTION

The main object of this invention is to offer a mechanism of adjusting irradiating angle for a far infrared radiator. It can randomly be adjusted to shift its irradiating angle without a dead one.

Another object of this invention is to offer a mechanism of adjusting irradiating angle for a far infrared radiator, which can be disassembled and folded up to shrink its size so as to lower package and delivery cost.

The main characteristics of the invention are a joint, an irradiating hood, and an elbow provided with a stage of corrugated flexible tube for combining the joint and the irradiating hood. The elbow is provided with a combining end portion connected with the corrugated flexible tube for combining with the irradiating hood, and a locking slot formed in a surface of the combining end portion for being tightly fitted with a screw extended inwards from a combining hole of the irradiating hood. So the corrugated flexible tube can be bent with diverse angles and; the irradiating hood can be circularly rotated; and the joint can let the elbow swing up and down. The irradiating hood can be thus adjusted to randomly shift its irradiating angle without difficulty.

Another characteristic of the invention is a stand provided with a cap that has a through hole for a supporting post formed with a female-threaded hole in its bottom to extend through and an opening formed in its bottom. The cap is also provided with a fitting recess cut at its four corners respectively, with a same depth for two of the fitting recesses diagonally positioned, and with a depth difference for two of the fitting recesses positioned next to one another. A bottom plate is fitted in the opening of the cap, provided with an engage sleeve extended upwards with a certain height to correspond to the through hole of the cap. The stand is also provided with two horizontal rods perpendicularly crossed together and fixedly fitted in the fitting recesses of the cap. Then a screw is inserted upwards from the bottom of the intersection of the horizontal rods through the bottom plate to threadably engage with the female-threaded hole of the supporting post. Thus the horizontal rods and the cap of the stand can be conveniently assembled or disassembled so that the far infrared radiator of the invention can be packaged in a minimum size for saving package and delivery cost.

### BRIEF DESCRIPTION OF DRAWINGS

This invention is better understood by referring to the accompanying drawings, wherein:

FIG. 1 is a perspective view of a preferred embodiment of a mechanism of adjusting irradiating angle for a far infrared radiator in the present invention;

FIG. 2 is an exploded perspective view of a stand in the preferred embodiment of a mechanism of adjusting irradiating angle for a far infrared radiator in the present invention;

FIG. 3 is a cross-sectional view of a stand in the preferred embodiment of a mechanism of adjusting irradiating angle for a far infrared radiator in the present invention;

FIG. 4 is an exploded perspective view of a joint in the preferred embodiment of a mechanism of adjusting irradiating angle for a far infrared radiator in the present invention;

FIG. 5 is a cross-sectional view of the joint in the preferred embodiment of a mechanism of adjusting irradiating angle for a far infrared radiator in the present invention;

FIG. 6 is an exploded perspective view of a corrugated flexible tube and an irradiating hood in the preferred embodiment of a mechanism of adjusting irradiating angle for a far infrared radiator in the present invention;

FIG. 7 is a side view of the preferred embodiment of a mechanism of adjusting irradiating angle for a far infrared radiator in the present invention, showing the joint being operated to enable an elbow to swing up and down;

FIG. 8 is a schematic side view of the joint in the preferred embodiment of a mechanism of adjusting irradiating angle for a far infrared radiator in the present invention, showing the joint being operated to enable the elbow swung to a first random position;

FIG. 9 is a schematic side view of the joint in the preferred embodiment of a mechanism of adjusting irradiating angle for a far infrared radiator in the present invention, showing the joint being operated to enable the elbow swung to a second random position;

FIG. 10 is a schematic side view of the joint in the preferred embodiment of a mechanism of adjusting irradiating angle for a far infrared radiator in the present invention, showing the joint being operated to enable the elbow swung to a third random position;

FIG. 11 is a schematic side view of the preferred embodiment of a mechanism of adjusting irradiating angle for a far infrared radiator in the present invention, showing the joint being operated to enable the elbow swung downward to a low position;

FIG. 12 is a schematic side view of the preferred embodiment of a mechanism of adjusting irradiating angle for a far infrared radiator in the present invention, showing the corrugated flexible tube being bent to enable the irradiating hood moved up and down;

FIG. 13 is a top view of the preferred embodiment of a mechanism of adjusting irradiating angle for a far infrared radiator in the present invention, showing the corrugated flexible tube being bent to enable the irradiating hood moved forward and backward;

FIG. 14 is a schematic side view of the preferred embodiment of a mechanism of adjusting irradiating angle for a far infrared radiator in the present invention, showing how the irradiating hood be rotated;

FIG. 15 is a schematic side view of the irradiating hood in the preferred embodiment of a mechanism of adjusting irradiating angle for a far infrared radiator in the present invention, showing the irradiating hood being rotated to a first random position;

FIG. 16 is a schematic side view of the irradiating hood in the preferred embodiment of a mechanism of adjusting irradiating angle for a far infrared radiator in the present invention, showing the irradiating hood being rotated to a second random position; and

FIG. 17 is a schematic side view of the irradiating hood in the preferred embodiment of a mechanism of adjusting irradiating angle for a far infrared radiator in the present invention, showing the irradiating hood being rotated to a third random position.

### DETAILED DESCRIPTION OF THE PREFERRED EMBODIMENT

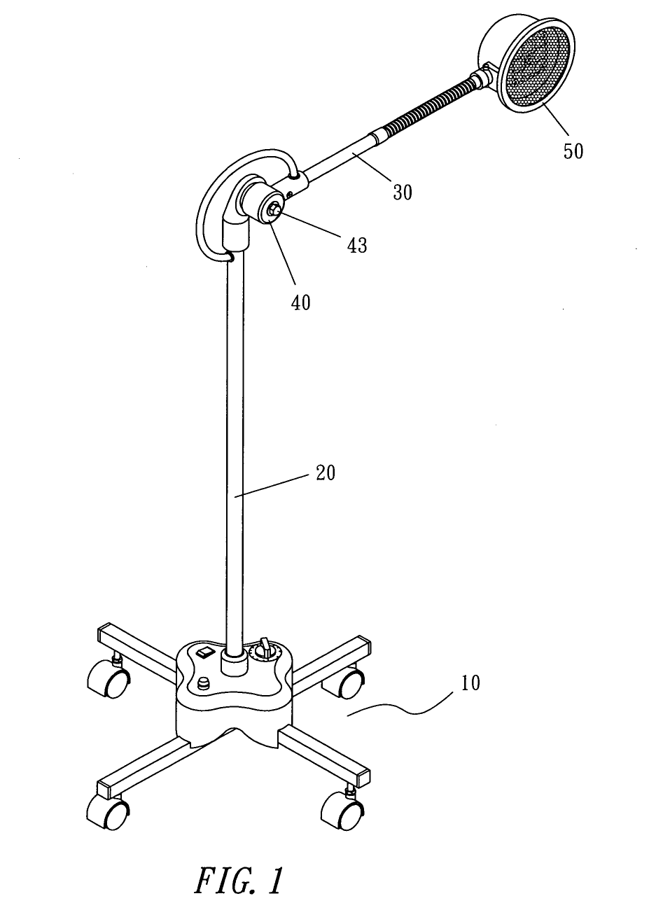

As shown in FIG. 1, a preferred embodiment of a mechanism of adjusting irradiating angle for a far infrared radiator includes a stand 10, a supporting post 20 positioned on the stand 10, an elbow 30, a joint 40 formed at one end of the elbow 30 for connecting with the supporting post, and an irradiating hood 50 jointed with the other end of the elbow 30 and installed with a far infrared heater.

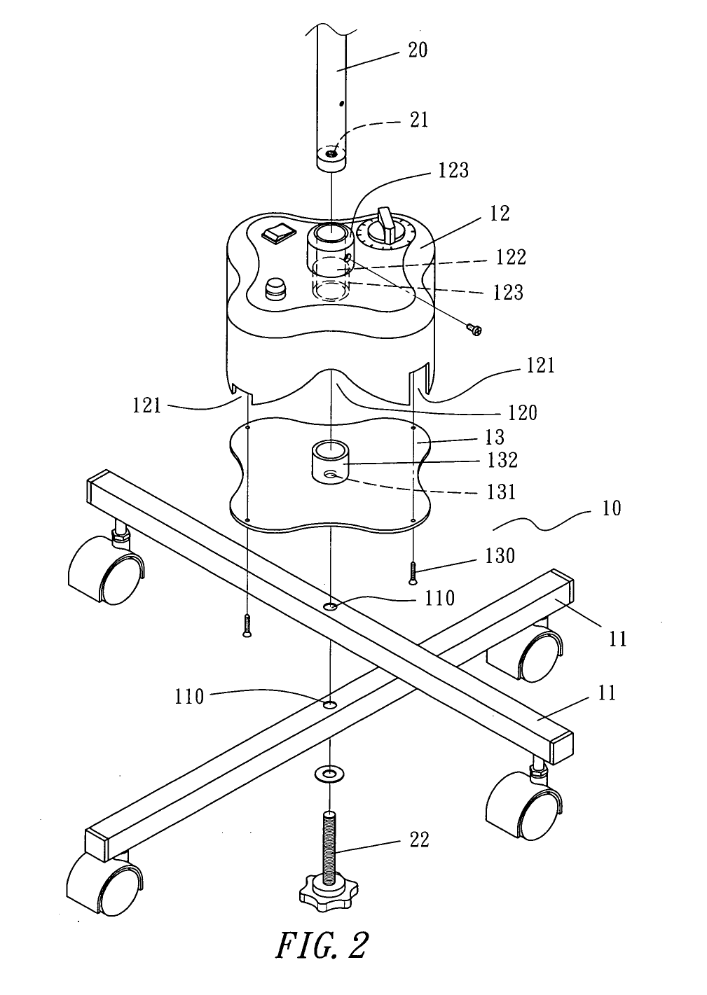

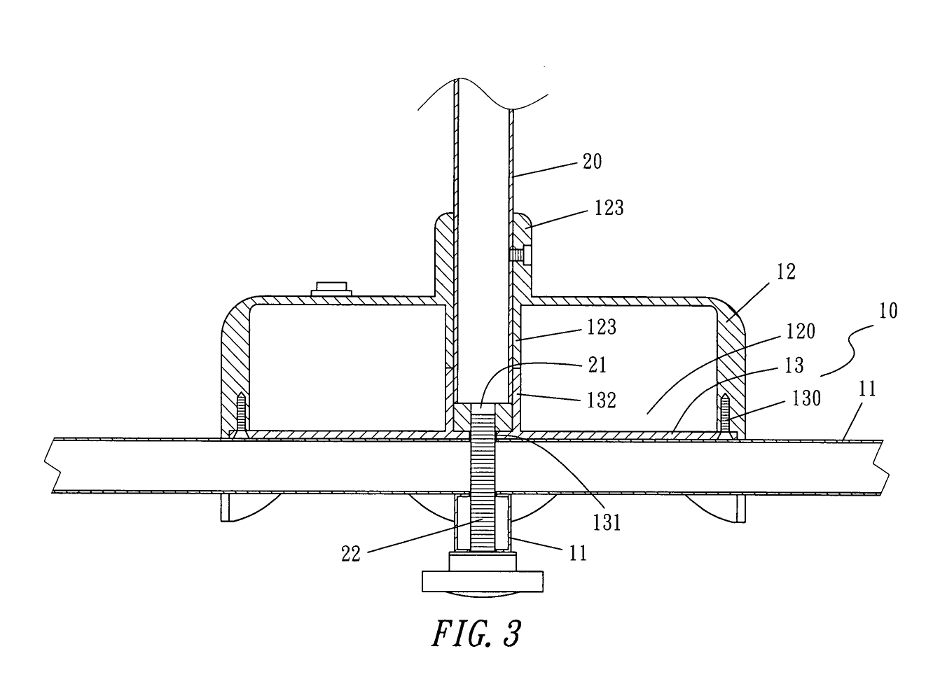

The stand 10, as shown in FIG. 2, is provided with two horizontal rods 11 perpendicularly crossed together and respectively bored with a hole 110 at the center to correspond to one another. The stand 10 further has a cap 12 positioned on the horizontal rods 11 and provided with an opening 120 formed in the bottom, and a fitting recess 121 cut at its four corners around the bottom circumference respectively, with a same depth for two diagonal fitting recesses 121 and a different depth of the height of the horizontal rod 11 for two adjoining fitting recesses 121 so that the horizontal rods 11 can be stably fitted in the fitting recesses 121 after perpendicularly crossed together The cap 12 is also provided with a through hole 122, and two supporting sleeves 123 respectively extended upwards and downwards from the upper and the lower edge of the through hole 122, with a certain length. In addition, a bottom plate 13 is inserted in the opening 120 of the cap 12, fixed together with cap 12 by screws 130 threadably inserted in preset threaded holes formed in the inner wall of the cap 12, as shown in FIG. 3. The bottom plate 13 is provided with a center hole 130, and an engage sleeve 132 extended upwards around the center hole 131 for engaging with the supporting sleeve 123 of the cap 12.

As shown in FIGS. 2 and 3, the supporting post 20 is provided with a female-threaded hole 21 formed in its bottom for engaging with a screw 22 to combine the horizontal rods 11, the cap 12 and the supporting post 20 together, with the bottom of the supporting post 20 extended into the opening 122 from the top of the cap 12 to press on the bottom plate 13, with the screw 22 inserted through the holes 110 from the bottom of the horizontal rods 11 and through the center hole 131 of the bottom plate 13 orderly. By the time, the bottom of the supporting post 20 is confined by the supporting sleeves 123 and the engage sleeve 132 so as to keep the top of the supporting post 20 from swinging.

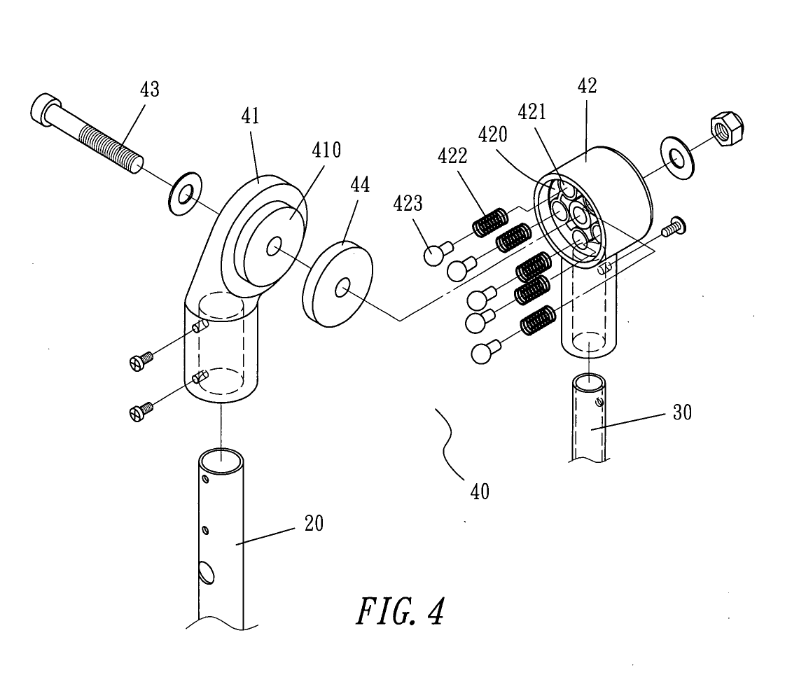

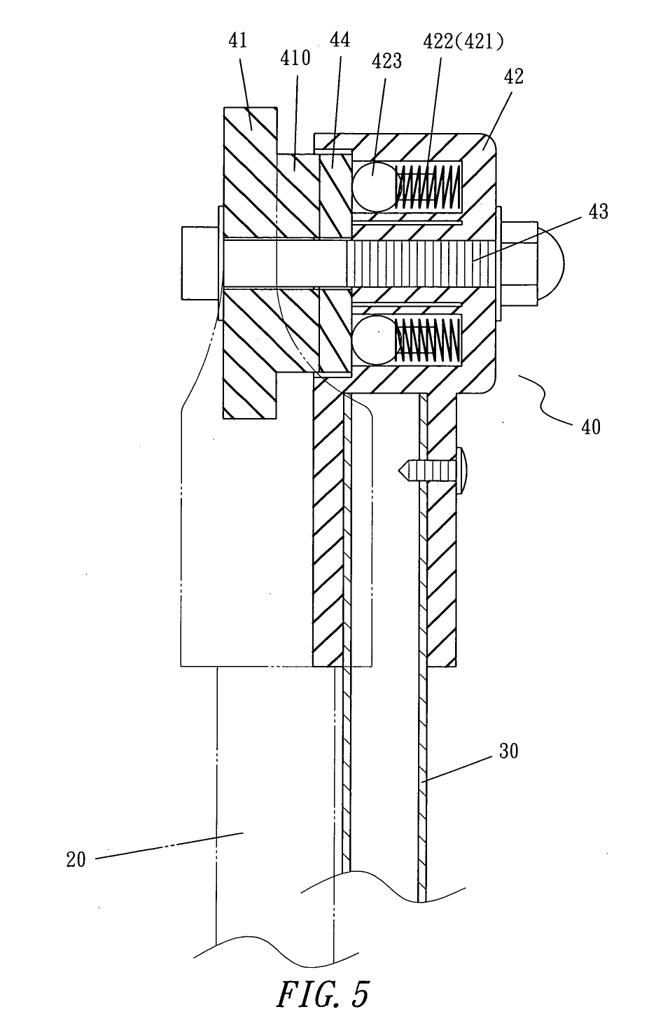

The joint 40, as shown in FIGS. 4 and 5, is mainly provided with a male engage member 41 and a female engage member 42 that are pivotally fixed together by a combining shaft 43. The male engage member 41 is provided with a circular engage surface 410 for fitting in a circular groove 420 of the female engage member 42. Plural accommodating tubular holes 421 are formed inside the circular groove 420 around its center, respectively containing a compression spring 422 and a rolling ball 423. And, an elastic anti-slipping washer 44 is placed on the rolling balls 423 so that it is positioned between the engage surface 410 of the male engage member 41 and the rolling balls 423 of the female engage member 42 after the male member 41 and the female member 42 are fixed together by the combining shaft 43. The inclined angle between the male member 41 and the female member 42 can be altered up and down with the combining shaft 43 being an axis. And, with the compression of the joint 40 to adjust the tightness of the male member 41 with the female member 42, the joint 40 can be instantly positioned immovably by the combining shaft 43.

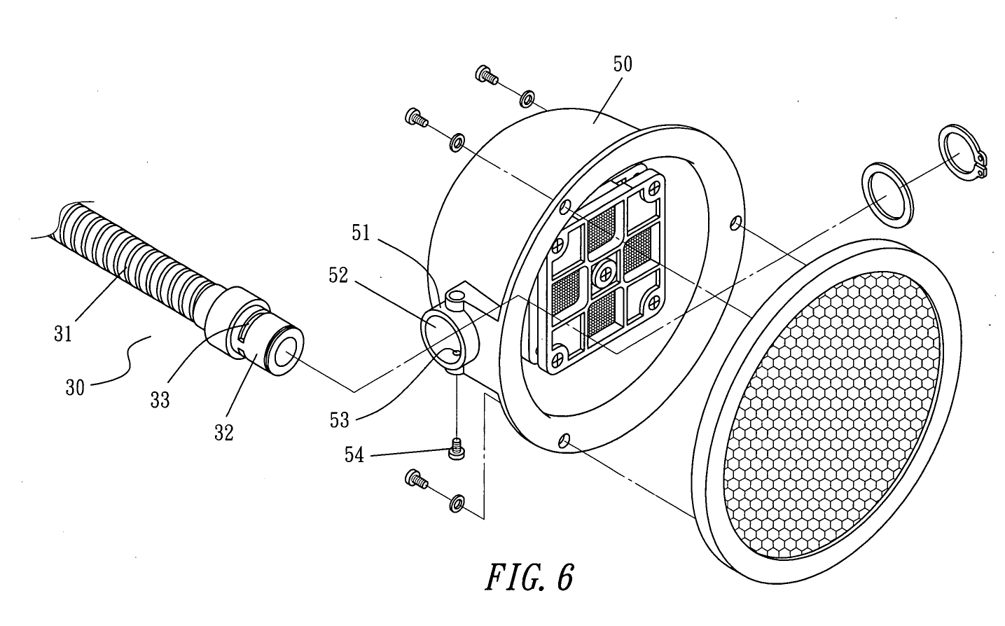

As shown in FIG. 6, the elbow 30 is provided with a stage of corrugated flexible tube 31 for being bent in diverse angles, a combining, end portion 32 being a rigid tube for connecting with the irradiating hood 50, and a locking slot 33 formed in the surface of the combining end portion 32. The irradiating hood 50 is provided with a combining tube 51 having a combining hole 52 for the combining end portion 32 to extend therein, with a C-shaped locking ring locked to combine the irradiating hood 50 with the elbow 30. Bored in the wall of the combining hole 52 is a through hole 53 that is to be inserted by a screw 54 from its outside to extend into the locking slot 33, so that the irradiating hood 50 can be combined with the elbow 30. And, with the elbow 30 employed as an axis, the irradiating hood 50 can be turned around to change its direction.

Next, the operating processes of the invention are described below.

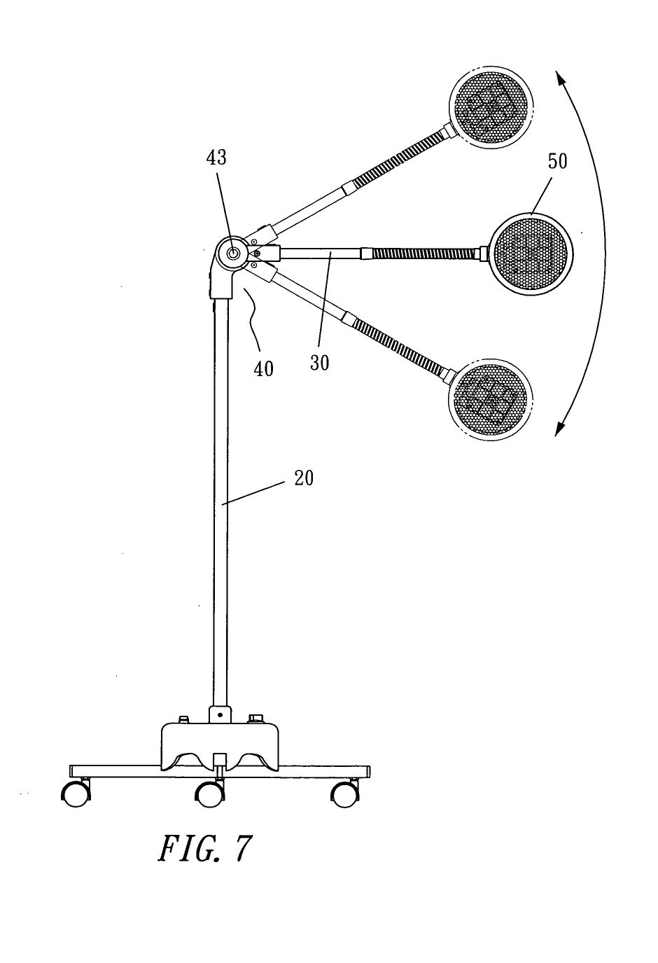

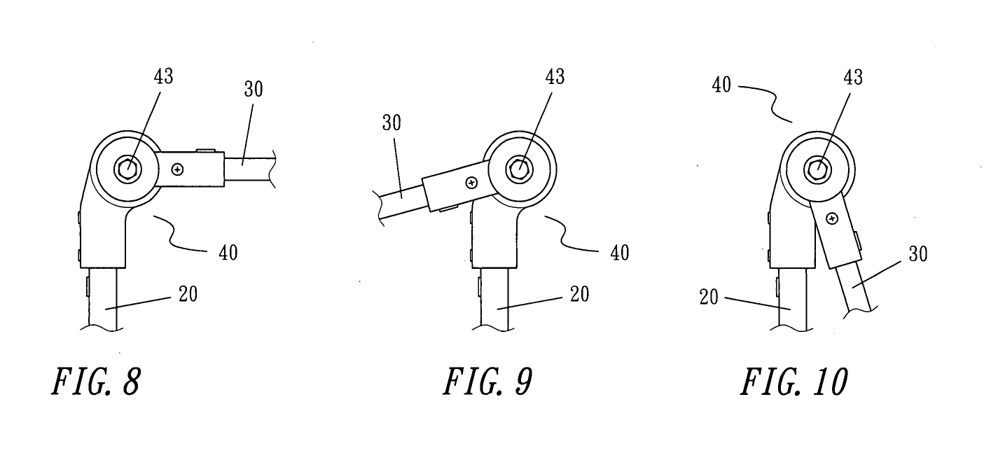

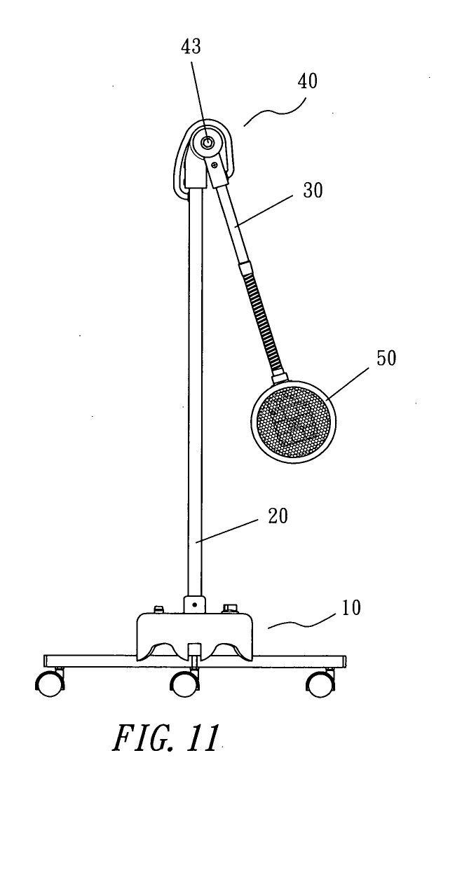

1. As shown in FIGS. 7˜11, with the elbow 30 grasped by a hand and the joint 40 used as an axis, the elbow 30 can be moved up and down to shift its angle; so can the irradiating hood 50 be moved simultaneously as it is connected with the elbow 30.

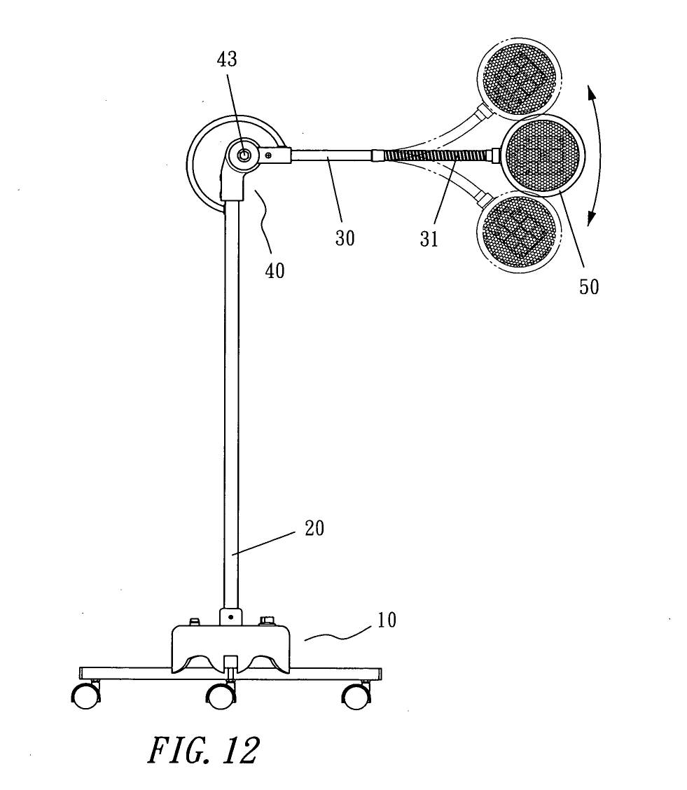

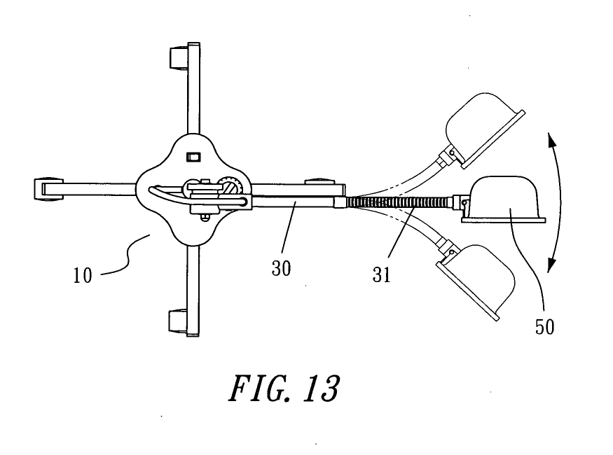

2. With the irradiating hood 50 held by a hand and the section of the elbow 30 close to the joint 40 working as a pivot, the corrugated flexible tube 31 can be bent up and down as shown in FIG. 12 or be horizontally bent as shown in FIG. 13 or be bent in any angle so as to enable the irradiating hood 50 to shift its angle.

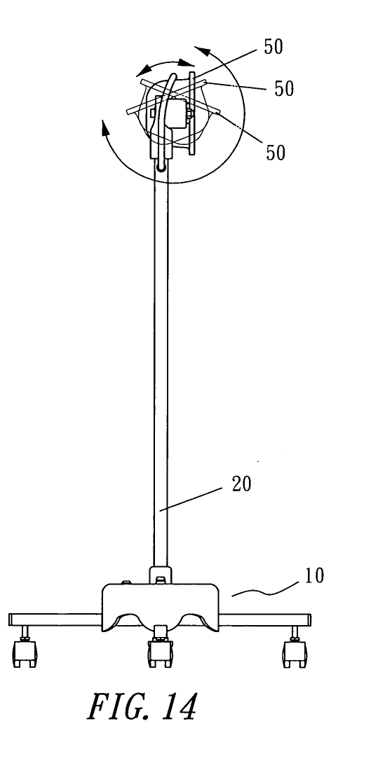

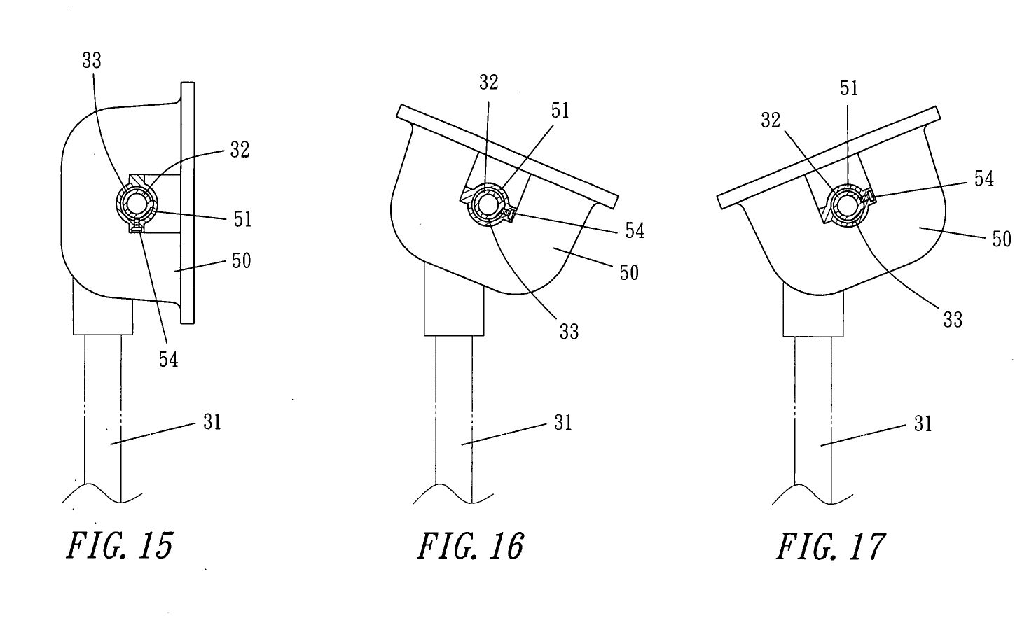

3. With the irradiating hood 50 grasped by a hand and the combining end portion 32 of the elbow 30 utilized as a center for the combining hole 52 to turn around thereof, the irradiating hood 50 can be rotated to shift its irradiating direction, with the screw 54 moving along the locking slot 33 of the elbow 30, as shown in FIGS. 14˜17.

4. The screw 22 can be threadably loosened off the horizontal rods 11 of the stand 10 and the cap 12, and by means of the joint 40, the elbow 30 and the supporting post 20 can be folded to approach to one another. Therefore, the far infrared radiator can be packaged into a minimum size so as to save cost of package and delivery.

The invention has the following advantages as can be seen from the foresaid description.

1. With the joint 40, the elbow 30 and the irradiating hood 50 can be lifted or lowered. With the corrugated flexible tube 31, the elbow 30 can be bent in diverse angles. And, the irradiating hood 50 can be rotated without moving. So a tremendous wide irradiating range can be covered by the far infrared radiator of the invention, permitting the irradiating angle freely adjusted with no dead angle.

2. The far infrared radiator can be packaged into a small size because the stand 10, the horizontal rods 11 and the cap 12 can be easily disassembled.

While the preferred embodiment of the invention has been described above, it will be recognized and understood that various modifications may be made therein and the appended claims are intended to cover all such modifications that may fall within the spirit and scope of the invention.

What is claimed is:

1. A mechanism of adjusting irradiating angle for a far infrared radiator, said mechanism comprising:
a joint employed to adjust a vertical angle and having its one end connected with a supporting post that is fixed on a stand and having another end connected with an elbow;
said elbow connected with an irradiating hood installed with a far infrared heater and provided with a section of corrugated flexible tube able to be bent to enable an irradiating hood to shift its position and its irradiating angle in 3-dimensional space; and
said irradiating hood provided with a combining tube having a combining hole for engaging with a combining end portion of said elbow, said combining hole bored with a through hole in its wall, a locking slot formed in a surface of said combining end portion for being reached therein by a screw extending into said combining hole from said through hole so that said irradiating hood can be turned around to change its angle.

2. The mechanism of adjusting irradiating angle for a far infrared radiator as claimed in claim 1, wherein joint is provided with a male engage member, a female engage member, an anti-slipping washer installed between said male engage member and said female engage member, a combining shaft extended through them to pivotally fix them together, said male engage member provided with a circular engage surface for fitting in a circular groove of said female engage member, plural accommodating tubular holes formed inside said circular groove around its center and respectively containing a compression spring and a rolling ball therein.

3. The mechanism of adjusting irradiating angle for a far infrared radiator as claimed in claim 1, wherein said stand is provided with two horizontal rods perpendicularly crossed together, a cap possessing a through hole for said supporting post to extend through and an opening formed in its bottom and a fitting recess cut at its four corners respectively for being atop fitted with said horizontal rods of said stand, a bottom plate fixed in a bottom of said cap, a screw inserted upwards through a bottom of an intersection of said horizontal rods and said bottom plate to extend into a female-threaded hole formed in a bottom of said supporting post for being threadably positioned thereof so as to keep said stand assembled together with said supporting post.

4. The mechanism of adjusting irradiating angle for a far infrared radiator as claimed in claim 3, wherein two of said fitting recesses positioned diagonally have a same depth and two of said fitting recesses positioned next to each other have a different depth of a height of said horizontal rod.

5. The mechanism of adjusting irradiating angle for a far infrared radiator as claimed in claim 3, wherein two supporting sleeves are respectively extended upwards and downwards from an upper and a lower edge of said through hole of said cap and an engage sleeve is extended upwards around a center hole of said bottom plate for correspondingly engaging with said supporting sleeve of said cap, so that said supporting post can be powerfully positioned after having its lower portion extended into and wrapped by said supporting sleeves of said cap.
